(19) United States
(12) Patent Application Publication
(10) Pub. No.: US 2015/0207832 A1
(43) Pub. Date: Jul. 23, 2015

(54) Non-Linear Discussions

(71) Applicant: Joshua Craig Pace, Salt Lake City, UT (US)

(72) Inventor: Joshua Craig Pace, Salt Lake City, UT (US)

(73) Assignee: Joshua Craig Pace, Salt Lake City, UT (US)

(21) Appl. No.: 14/160,540

(22) Filed: Jan. 21, 2014

(51) Int. Cl. H04L 29/06; G06F 3/0484; G06F 3/0482

(52) U.S. Cl. CPC H04L 65/403; G06F 3/0482; G06F 3/04842

(57) ABSTRACT

A non-linear discussion network comprises methods and technologies that include storing, associating, accessing, and communicating actions; and further displaying discussion sets as well as other information to viewing users.

### BACKGROUND OF INVENTION

We live in a world that is more connected than at any other time in history, and yet, ironically, we seem to be more and more isolated from each other. We have the tools and technology to stay connected, but our communications are mostly superficial and seem to be devolving into an endless stream of texts, tweets, status updates, and recycled or regurgitated pictures, links and videos. Companies have made billions of dollars developing technologies that make connecting with friends and family incredibly easy. Yet, despite all these technologies, there is a large segment of communication that remains untapped. The reason for this untapped segment is that conventional communication has severe limitations making it ineffective and insufficient for enabling, deep, rich, far-reaching and long-lasting discussions amongst friends and social circles—or any individuals who desire to communicate on a deeper, more substantive level.

Perhaps the biggest limitation of conventional interpersonal communication, and the basis for almost all other related limitations, is that conventional interpersonal communication is linear; one person speaks, then another responds, then another, and so on—with each subsequent response depending on prior responses for context, clarity and cohesion. While linear discussions are ubiquitous and definitely have their place, they possess qualities that make them ultimately unsustainable, including but not limited to: capricious trajectories, finite life spans, isolation from similar discussions, and dependance on a sole primary contributor. Consequently, these communications rarely reach a high level of engagement, longevity and depth. Discussions over conventional mediums (i.e. text messaging, social networks, emails, message boards, live discussions and so on) quickly expire, or the discussion eventually becomes unmanageable or otherwise difficult to navigate as it topples under the weight of it's many disjointed replies and subthreads.

One of the most significant limitations of linear discussions is that there is a practical limit to the number of people who can actively participate (this is especially evident in live discussions). Linear discussions have limited life spans and participants have limited attention spans. As a result, each additional participant cannibalizes the time and ability for other participants to elaborate on their thoughts, opinions and experiences.

A non-linear discussion system, one that overcomes the limitations of conventional communication, would deepen, enrich and expand current communication capacities and would thus be a significant advancement in the art.

### SUMMARY OF INVENTION

An advancement in the art of communication to create or otherwise enable a non-linear communication tool, method, system, device, and/or service that overcomes the limitations of linear communication methods and technologies is presented. This includes generating a discussion set for a viewing user of a non-linear discussion network comprising: storing actions performed by users of the non-linear discussion network; associating each action and each user who performs the action to a binder; accessing information for at least one binder; generating a discussion set, the discussion set including information from at least one binder and associated actions; and displaying the discussion set to the viewing user.

### BRIEF DESCRIPTION OF DRAWINGS

FIG. 1 depicts a current communication landscape.

FIG. 2 illustrates Echoes as part of a non-linear discussion matrix.

FIG. 3 illustrates a graphical representation of a navigable user list.

FIG. 4 illustrates a graphical representation of a navigable binder list.

FIG. 5 illustrates a display format of a question (or binder) with associated actions by one or more users and supporting information and user options.

FIG. 6 illustrates a display of a “Discussion Summary” format.

FIG. 7 illustrates an exemplary environment for generating echoes in discussions that are personalized for users of a web-based non-linear discussion network.

FIG. 8 illustrates a block diagram of a content engine.

FIG. 9 illustrates a flow diagram of a process for generating a personalized discussion set to a viewing user.

FIG. 10 illustrates a diagram of relationships for processing actions and requests and generating a personalized data set to a viewing user.

FIG. 11 illustrates a flow diagram of a user experience in a non-linear discussion network.

### DETAILED DESCRIPTION

An “Echo” as used throughout this description, refers to a basic building block of a non-linear communication system. An Echo is an independent collection of one or more actions by a user on one or more binders/questions/subtopics relating to a specific subject or topic. Echoes can be enjoyed on their own, but their real power is in how they can be combined with any number of other Echoes to create a unique, deep, rich, engaging and far-reaching discussion experience.

An “action”, as used throughout the description, may refer to how a user may engage with a binder. For instance, a user may pose, follow or respond to a question. In this way, an action may be thought of as user-generated content that can be stored, queried and displayed to other users. When a user performs an action, that action is considered to be added to that user's Echo.

A “binder” as referred to throughout the description, may comprise a question, a subject, a request, a statement, and/or other actionable items that a user may engage in independently of other users. With many different users acting independently on the same binder, the binder can be thought of as a common binding element associating the independent actions of multiple users together. Along with the actionable item, a binder may include subsequent actions, such as responses, subjects, requests, and other actions that follow the initial action.

Like actions, binders may be considered to be part of the user's Echo. For example, in a context of a binder that comprises a question, when a user responds to that question, the question and the binder become a part of the user's Echo. In a similar context, a user may follow the question that he or she finds interesting and it is added to their Echo even though he or she may not have responded to the question. Finally, if a user decides to create a binder by posing a question, the binder then becomes associated with the Echo in the same way as when following a question.

A “discussion”, as currently envisioned, includes the combination of any number of Echoes, with associated actions and binders. In other words, it may comprise a collection of all the questions related to a particular discussion topic in which the user, or the user's friends, have participated in (e.g. responded to or are currently following). These questions may then be arranged in chronological order beginning with the most recently responded to or followed question. Note that there may be some other useful ways to sort or arrange the questions.

Note that the discussion may include the Echoes that the viewing user is privy to. Alternatively, it may include all Echoes by all users. Moreover, it may include certain Echoes that are predefined by the system, selected randomly, selected by the user, or allowed in some other manner.

A “topic” or “subject” simply refers to the subject matter or label given to a particular discussion. For example, a topic on sunshine may include several binders, involving questions and answers, surrounding weather patterns, as well as questions and answers surrounding summer vacation. In this manner, a user may peruse a subject from a bird's eye view and then hone in on more specific questions and answers.

A “discussion set” refers to data comprised of any combination of actions, binders, and users that is displayed to a viewing user. A discussion set may include, for example, a single Echo with associated actions and binders, a single binder with associated actions and users, and/or a list of binders with associated data. Associated data may include, for example, a list or numbering of friends/users that are following a certain question, and/or a list or numbering of friends/users who have answered a certain question, and/or a history or summary of answers by a certain friend/user to a certain question. Other types of discussion sets are envisioned.

CHOOSING A TOPIC—For a user to begin an Echo, the user may perform a variety of actions. For example, the user may first create, select, or otherwise choose a discussion, topic (subject), or binder.

For a topic selected, questions or subtopics may be created by the viewing user or by any other user of the community (including admins and/or moderators), thus starting the basic framework for a non-linear discussion. These general topics may be created by the viewing user, other user, administrator, or other, and may include at least a subject title, and may also include a description/introduction, a category (or location), images, links, videos, ratings, comments and any other supporting information.

The processes of searching for and creating new topics may be as intuitive for the user as possible, and user-facing and server-side methods may be employed to minimize subject duplication. Some of these methods may include an efficient search algorithm that suggests the best topics for the user and a few “catches” that catch any possible direct matches for the subject the user is creating. Minimizing duplicates helps to centralize all echoes/contributions and maximizes the visibility of those contributions to the most people.

Methods may also exist for peers and/or administrators to be able to validate, approve, edit, categorize and otherwise manage subjects. These methods may include: the ability to directly edit the topic along with any supporting information; the ability to authorize a topic and its associated content for posting to third party social networks and other social media tools; the ability to ban a topic and any associated content from public use; the ability to contact the topic author; the ability and flexibility to ban the topic author for any duration deemed necessary; and the ability to flag duplicates and the ability to merge the content of any duplicate topic.

POSING QUESTIONS—Once a topic has been chosen, there may be a way to associate, pose, or create questions or subtopics that relate to the selected topic.

It can be argued that certain types of questions are better for Echoes (non-linear discussions) than others. Accordingly, the process for posing or creating questions may facilitate, inspire or otherwise encourage the ideal type of question and may also expand the user's thinking as to what types of questions may be asked. To this end, there may be a series of question types or categories that users may select as they are posing a new question. Such question types may include (but are not limited to): questions about experiences, questions about actions and choices, questions about feelings and emotions, questions about perspectives and opinions, questions about interests, wishes and desires, questions about details, specifics or descriptions, academic questions, hypothetical questions, questions for general information, questions for general advice, questions about reactions and responses, questions about challenges, fears and anxieties, and so forth.

Once a user selects a question type, it may be useful to display other questions of that type that are currently in use for the related general discussion subject. This step may help minimize duplicates and may simultaneously promote interesting questions through the site/community.

If the user decides to pose a new question, he or she may do so by simply typing a question into a text field. Steps should be taken however, whether by programming or by an official review process, to help the user ensure that his or her question is the way, devoid of spelling and grammatical errors, is related to the question type selected, and that the question abides by the site's Terms of Service or other guidelines.

Questions that are posed may relate to more than just a few people and may be made available for everyone in the community regardless of friendships or connections. This helps to ensure that interesting questions are made available to the widest number of people.

When a user poses a new question, the user may be automatically considered to be also “Following” the question. This may be done so that this question automatically appears on the user's “Echo” for this general subject and the question and subject may be visible to friends of the user.

When a user poses a question, there may be several types of notifications that are triggered for the benefit of the user, the user's friends, general community and site administrators. These notifications may possible include one or more of the following: an alert for other users who have “joined” the same discussion subject letting them know that a new question has been posed; an alert to administrators that a new question has been posed and that it should be subject to a review; a notification to the user's friends that the user has posed a new question; and so forth. [See NOTIFICATIONS below for more information]

FOLLOWING QUESTIONS—When a user “Follows” a question, several things may happen: the question may be added to the user's “Echo” (making it visible to the user's friends or other readers of the Echo); the user may be subsequently notified of any activity (i.e. responses) of friends or possibly others related to that question [see NOTIFICATIONS]; the user's friends may be notified that the user has elected to follow this question [see NOTIFICATIONS]; and the user's friends may have more incentive to respond to the question as a result of the user's interest in the question [see DISPLAYING QUESTIONS].

As a means of motivating users to follow questions, it may be beneficial to allow special privileges to question followers. For instance, if a user is following a question, he or she may gain access to viewing responses from people outside of his or her network. He or she may also receive alerts when new responses written by outsiders are posted. In this way, a user may have incentive to follow questions of interest and without relying on friends to post responses.

Tracking which questions are being followed, and in which subjects, may be an effective way of determining general interest and this information can subsequently be used to determine a popularity ranking that may be used to filter/order search results. For example, a list of questions within a discussion may be arranged based on the number of people in the community (or number of the user's friends) who are following the question. Likewise, a list of popular subjects can be compiled based on the popularity of questions within the subject. What makes this data significant is that there may be limits to the number of questions a user may follow at any one time -- this helps keep the data current and relevant.

The action of Following a question may also be a candidate for something that triggers a notification on behalf of the user on a third-party social network.

ADDING NOTES (OR OTHER INFO) TO QUESTIONS—Ideally, whenever a question is posed, it may be made available to all members of the general community. However, there may be a reason for any user to append supporting/clarifying Notes to the question. Such notes may be made available to all, however, embodiments include that they may be made only visible to friends of the author of the notes. This would allow users to add personal embellishments that their friends might find useful without disrupting or otherwise diminishing the experience for other users. It may be useful to limit the ability of adding notes to those users who are “Following” the question. The ability to add other supporting information to the question (links, videos, images, etc.) may also prove useful.

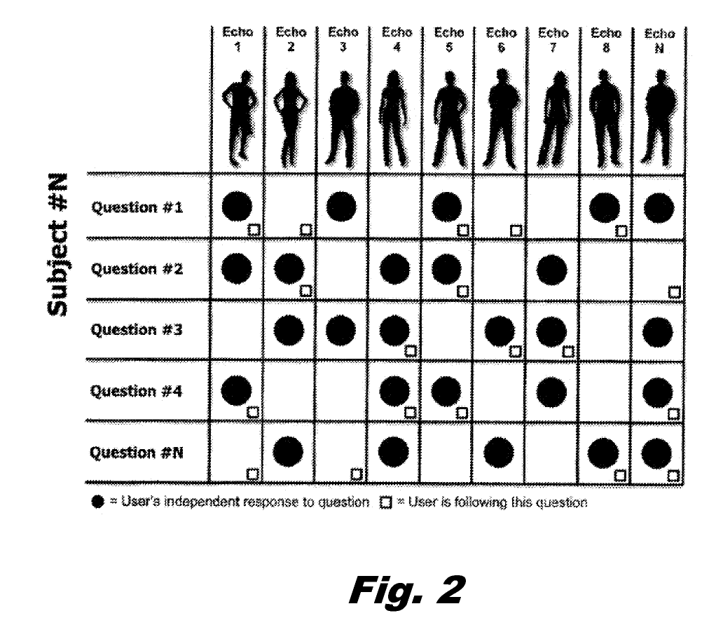

RESPONDING TO QUESTIONS—Once a question has been posed within a general subject, users may write responses and subsequently edit those responses. These responses may then be “added” to the user's Echo. Using an example of a spreadsheet, the Subject can be thought of as the spreadsheet's title; the Users may be thought of as the columns; and Questions/subtopics may be thought of as the rows (FIG. 2). When a user responds to a question, their response is added (conceptually) to the appropriate row in their “column”. A user's “Echo” therefore, is essentially a representation of all the data in the user's “column” (their responses, the questions they have responded to, and the questions they are currently following).

When a user writes/posts a response to a question, several things may happen: the response may be added to the user's Echo (as stated above); the user's friends (and others) may receive notifications, emails or other alerts letting them know that their friend has responded to a question; a notification may go out on a third-party social network or other social media tool alerting users of that community of the user's response, the question they responded to and/or the subject the user has “Echoed”. [see NOTIFICATIONS for more information].

Responses to questions may include other data besides text. This supplemental data may include links, videos, images, rankings and so forth. Of particular mention may be the ability of an author to associate an emotion (whether by selecting a word or phrase, or by selecting an image that represents a particular emotion). The emotion may then accompany the response when it is displayed for readers. How the emotion is displayed, and when it is displayed, may be very effective in enhancing the experience for users of this communication method. [see DISPLAYING ECHOES for more information]

DISPLAYING ECHOES (SUMMARY REPRESENTATIONS)—How Echo summaries are displayed, represented and accessed may be crucial to the user's experience and may heavily influence the user's use and adoption of an Echoes system as a communication medium. Embodiments include that Echo summaries be displayed and represented in such a way that conveys important information to the user without confusing or overwhelming them with information. Important information may include one or more of the following: the Echo author's image, name, the date the Echo was last modified, the number of responses within the Echo, the number of questions the author is following, an associated emotion (a general emotion or on selected in relation to a particular response), whether or not the Echo contains responses that the user hasn't read, and so forth.

The manner in which Echo summaries are aligned on a page or device is also important. We have determined that a horizontal alignment with Echo summaries displayed one after the other may be an appealing format as it can quickly and cleanly convey the important information as well as conveying a sense of how popular a subject is, or how many friends (and which friends) have Echoed a given discussion. The number of Echoes may exceed the page width and so the ability to dynamically scroll the line of Echo summaries, or to paginate them, may prove useful. As presently embodied, the horizontal “Tabs” design is also appealing because it maintains continuity and functionality when displaying the full, individual Echoes. Horizontal alignment is also intuitive when displaying Echoes in chronological order.

DISPLAYING ECHOES (FULL ECHO)—There may be several effective ways to display the content of an author's Echo. The type of data contained in the Echo (text, images, video, links, emotions, etc.) may greatly impact the manner in which the data is or should be displayed for maximum effectiveness. Thus, embodiments may include that the primary data collected is the author's written responses to questions. As such, displaying each question with the author's response directly underneath in an “interview” style may provide a format that is easy to read and familiar to the reader. Also, the user may have options to engage with the question (i.e. Respond, Follow, Add Notes, etc.) [see DISPLAYING QUESTIONS for more information]. The number of questions displayed on the page may vary from one-at-a-time to multiple-questions-per-page to all-questions-at-once. Methods may be employed, when necessary, to help the user navigate through an Echo seamlessly, intuitively and easily.

COMBINING ECHOES INTO DISCUSSIONS—The beauty of an Echoes system is that the underlying, independently-written responses may be dynamically combined with any number of related responses from other Echoes without disrupting the integrity or feel of the discussion.

A “discussion”, as referred to at the beginning, is the combination of any number of Echoes a user is privy to. Embodiments include that questions in the “discussion” be displayed one at a time (though there may be a reason to display multiple questions on the same page) with tabs representing the currently-viewed question as well as other questions in the discussion. These tabs may contain important summary information. For example, the tab may show how many responses have been written for a particular question (that the user is privy to). The tab may also represent whether or not there are any responses to the related question that the user has not read. The tab may also display the actual question via some kind of pop-up display mechanism. The tab may also display how long ago the latest response to the question was modified. Further information may also be displayed.

When viewing the responses to a particular question in the discussion, the question may be displayed with any supporting information and options [see DISPLAYING QUESTIONS]. Underneath (or in any other alignment) the question, the responses the user has access to may be displayed vertically in chronological order beginning with the most recently-modified response. Responses may include any other relevant data including: the author's image, the author's name, the date or time it was last modified, the number of comments, the number of “likes” an emotion (graphic or text), links, pictures, videos, rankings, etc. Users may also be able to engage in a meaningful way with the responses they view. This may include: the option to add comments, the option to “like” the response, and so on.

DISPLAYING QUESTIONS—How questions are displayed, along with their supporting information, may have a significant impact on the user's experience and on whether or not a user chooses to engage with it. Supporting information may include the total number of people following the question, the number of the user's friends following the question, the name of the person who initially posed the question, any additional notes embellishing on or supporting the question, option for the user to Respond to a question (or edit their response), option to Follow the question, option to add/edit Notes, option to view all responses (if not displayed), the question's Type or Category, and so forth.

Embodiments include that questions be displayed prominently on the page with a large font and bold type-face. Above the question, the user's friends who are currently following the question may be displayed (either their image or their name) in such a way as to suggest their interest or involvement with the question. A total tally of all Followers may be included as well as the name of the initial author of the question. Below the question may be displayed additional notes added by the user or other members of the community. Options/buttons/links may further be included for the user to be able to Respond to, Follow, or Add/Edit Notes. There may be various effective ways of displaying the question, notes, options and followers including dynamic fields that display with a click, hover, scroll, etc.

As an added incentive for users to follow questions, it may be beneficial to display with the question the number of outsiders' responses the user will gain access to if they choose to follow the question.

FOLLOWING/INVITING FRIENDS—It may be beneficial to the user experience to allow users to invite and/or follow their friends (or others). Following/Inviting friends, as presently envisioned, would allow a user to be notified of any or all activity by the friend the user is following within a specific discussion/subject. Following/inviting friends also provides several benefits to the friend being followed/invited. For instance, the subject may come to the attention of the friend when the user might not otherwise know that the subject exists. Also, the more invites/followers a friend receives, the more likely the friend might want to engage in the discussion.

When a user has “Followers” in a specific discussion, the followers may be displayed so that the user may know 1) that they have followers and 2) the names of the followers. Embodiments includes that a user's followers be displayed in a vertical alignment on the side of the page, or other arrangement, to distinguish followers of the user from followers of any given question.

When a user follows a friend (or other individual), the user may elect to receive notifications of some or all the friend's activity relating to a specific discussion. For instance, the user may receive a notification when the friend responds to, follows or poses a question. The friend also may receive a notification that lets him or her know who is inviting/following them, which discussion is being followed (or invited to), and other relevant details. [see NOTIFICATIONS for more information].

FILTERING CONTENT BY INDIVIDUALS, GROUPS, CATEGORIES, QUESTION TYPES, ETC.—One of the most significant benefits of Echoes is that their underlying data can be filtered, parsed, sorted and re-arranged in many different ways without sacrificing the integrity of the discussion. In the current embodiment, different types of information can be filtered in different ways. For instance, a page displaying recently-active subjects (along with representations of any Echoes within the subject) may be filtered according to any user-defined (or site-defined) groups of people. The sorting mechanism would be able to retrieve a different result set based on the activity of members of the group. Any displayed Echoes may also be limited to just the members of the selected group. These groups may also be used to filter the content within a discussion, so that only responses from the selected group are displayed. Subjects may also be filtered by the Category (or Location) associated with the subject (for instance: display only Sports-related subjects). Questions may be filtered by the Type that the question is associated with (i.e. Hypothetical Questions). On member profile pages, all content may be filtered to display only Echoes, responses, comments, etc. written or selected by that member.

DISPLAYING “MOST RECENT” DATA—Ensuring that the user is presented with the most recent and relevant activity may be advantageous for providing an engaging user experience. Embodiments include a way to determine which discussion subjects are the most recently active, which questions are the most recently active, and which Echoes are the most recently modified. A subject, question or Echo is “modified” or “active” when a user Poses, Follows or Responds to a question. By being the most recent author (amongst the user's friends) to “Echo” the discussion, the user's Echo moves to the front of the list of Echoes for that discussion. The question also moves to the front of the list of active questions in that discussion. Consequently, the discussion/subject moves to the front of the list of subjects. For instance, when the user logs in, the user is usually taken to the user's personal “homepage”. The homepage, by default, displays the most recently-active discussions. Along with each discussion subject, there may be a list of Echoes (Echo summaries) with which the user has access. The most recently-modified Echo is displayed first with other Echoes following in chronological order.

NOTIFICATIONS—Notifications may comprise alerts triggered by certain user actions. Notifications may provide benefits to users, friends and administrators and they further ensure an engaging and satisfying user experience. User-facing notifications keep the user apprised of recent and relevant activity, help make the user feel special, and give them a sense that “things are happening here”.

Embodiments include several types of user-facing notifications: Recent Likes, Relevant Comments, Recent Invites/Followers, Recent Responses, and Recently-Posed or Followed Questions. All of these notifications are triggered by the actions of the user's friends. Because notifications may have a significant positive psychological affect on the user, new notifications may be represented prominently on the page (e.g. graphics at the top of the page representing the different types of notifications and which light up or change color when there are new notifications for the user).

When a friend “likes” a user's response to a question, or a comment they posted, the user may receive a Like notification. This Notification may display information relevant to the Like (i.e. the friend's image, name, the question the user responded to, a link to the user's response, a link to the user's comment, when it was liked, the relevant general discussion subject, and so forth.

When a friend adds a comment to a user's response, or if a friend adds a comment in a comment thread that the user has participated in, the comment may be considered “relevant” to the user and the user may be notified. Embodiments include that the Notification display the commenter's image, name, the comment itself, the time the comment was posted, a link to the related response or comment, the corresponding question, and so on.

When a user's friend(s) invite the user to follow(or be followed) the friend(s) in a discussion, the user may receive a notification displaying the image or name of the friend(s), the time that the user was invited/followed, the subject they are being invited to (or followed in), any questions the friend might be following, and so forth.

If a user is Following a specific question or a specific friend in a discussion, the user may receive a notification when any of the user's friends (and/or others) respond to the question, or whenever the friend being followed responds to any question in the discussion. The Notification may display the name/image of the response author, the question being responded to, the subject the question is associated with, the time the response was posted/modified, and so forth.

It may be beneficial to alert the user when friends follow or pose questions. These notifications may display the name/image of the individual who posed or followed the question, the question, the discussion subject associated with the question, the time the question was posed/followed, and so on.

DISPLAYING AUXILIARY DATA—It may be beneficial to the user experience to display, or give access to display, other useful content. For instance, allowing a user to see which discussions friends have recently joined. The results could then be filtered by user-defined (or site-defined) groups of friends, or by the categorization of the discussion subject. Other useful data might include recent comments made by user's friends, recent responses by friends, recent invites/followers, etc.

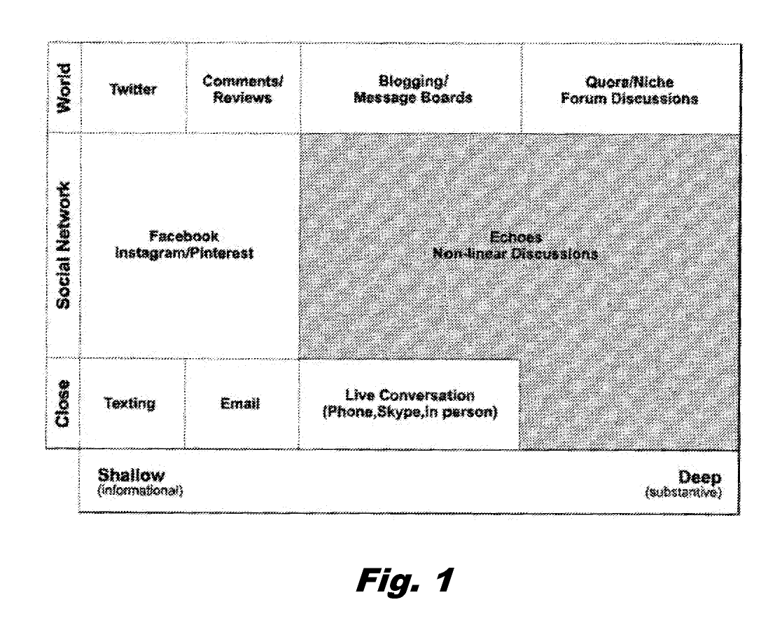

Turning to FIG. 1, a diagram portrays a current communication landscape and how different communication methods, companies and technologies served needs of consumers. For example, the world may send and receive communications via paths that include Twitter, comments/reviews, blogging/message boards, and quors/niche forum discussions. On a smaller spectrum, social networks may communicate view pathways that include Facebook, Instagram,and Pinterest. On an even smaller scale, personal communication may be accomplished via texting, email and live communication (e.g. phone, skype, in-person). From the left to right, communication may be seen as growing in depth from shallow to deep, informational to substantive. Visualized in this manner, one may readily discern that new forms of communication are needed to strengthen and enrich the landscape.

A space labeled “Echoes Non-linear Discussions” represents a space of communication that remains largely untapped because of inherent limitations and challenges of current forms of communication, current forms consisting of linear communication. In a non-linear structure, the following advantages are present:

Modularity/Mobility—In a non-linear structure, each participant's contributions (in totality referred to as their “Echo” of the discussion) exists separate and apart from (or are independent of) the contributions (or Echoes) of any other participants. This “modular” structure allows Echoes to be very versatile and “mobile”. Any combination of Echoes within a discussion may be arranged without any loss of continuity or comprehension.

Unlimited Shelf Life—The independent nature of non-linear communication (as embodied by Echoes) makes the overall discussion immune to the systemic degradation that plagues linear communication methods (i.e. dependence on prior comments and contributions as well as the inability to support large numbers of participants). As a result, the shelf life of non-linear discussions may be extended indefinitely.

Inertia/Continual momentum—By extending the shelf life of a non-linear discussion, the discussion may exist in perpetuity regaining relevance and momentum with every new contribution. For instance, a previously active discussion might lie dormant for several months, but then may be revitalized within a certain social circle when someone poses, follows or responds to a question. To that individual's friends, the discussion is once again active, relevant and vibrant. In this sense, non-linear discussions may become living, breathing entities unto themselves . . . always growing, becoming more and more interesting and compelling, yet never crumbling under their own weight.

Unlimited number of participants—The notion of an “ever-growing” perpetual non-linear discussion applies not only to the contributions of individual participants but also to the ability of a non-linear discussion to accommodate an unlimited number of participants without any loss of integrity, comprehension or relevance. When a linear discussion reaches a practical limit to the number of participants and the amount that each participant may contribute (due to cannibalization, limited shelf life, etc.), a non-linear discussion is only amplified by each additional participant and their contributions.

Centralization (vs Isolation)—By existing in perpetuity, and having the ability to accommodate an unlimited number of participants, non-linear discussions (as embodied by Echoes) have the ability to become centralized hubs for discussions that would normally exist in isolation. This allows the efforts of a motivated few to be leveraged for maximum benefit to all participants (i.e. posing, following or responding to questions). This is contrary to the behavior of linear discussions in which the contributions of the motivated few are often marginalized, stifled or even ignored due to either the limited shelf life of the discussion or due to suffocating weight of a discussion that has outgrown its usefulness.

Interest is known—Non-linear discussions (as embodied by Echoes, and integrated with a social network) have the added ability to eliminate one of the biggest hurdles preventing us from engaging in more interesting discussions with our friends, namely our inability to access their levels of interest in different topics. Echoes make it easy for a users to establish and convey which discussion topics are currently the most interesting and relevant to the people in their social circle.

Both linear discussions and non-linear discussions have their place, and non-linear discussions may or may not be viewed as a replacement of linear discussions. Perhaps non-linear discussions may better be seen as a compliment to linear discussions in that non-linear discussions make possible a type and depth of communication that has been otherwise very difficult, if not impossible, to achieve. Note that questions and topics that rarely surface in other technologies and mediums can thrive within the Echo structure.

Turning to FIG. 2, a diagram depicts the basic concept of non-linear discussions. For a visual understanding, a non-linear discussion may be portrayed as a matrix with each participant and his or her actions represented by individual columns (or “Echo”) separate and apart from all other participants. The rows of the matrix as shown may be communal questions (or other “binding” elements) relating to the discussion topic that has been posed by, or suggested by, any of the discussion participants or members of the larger community. In a non-linear discussion (as embodied by Echoes), participants are free to pose, follow or to respond to questions (or make any other contributions) at any time without jeopardizing the integrity or continuity of the discussion.

As shown, darkened circles appear in some of the squares in the matrix. These circles demonstrate that a user has responded to a question. One can readily discern the number of questions that have been answered by each individual. For each question, one can see the individuals that have responded to any given question. Furthermore, for one individual, one can see the questions that he or she has responded to. Thus, the non-linear network provides a means whereby discussions can be tailored to each individual's interest.

Also shown are small hollow squares in some of the right lower corners of the squares in the matrix. A small hollow square in a matrix square demonstrates that the user of that matrix square is following the question. Thus we see that a user may choose to continue with the discussion after responding or simply respond to the question and then be done with it. Embodiments further include that the user may follow the question/binder passively, not providing any response but maintaining an awareness of the happenings.

By design, a non-linear discussion may have no expiration date and may accommodate a limitless number of participants. Embodiments include, however, that expiration dates do exist for a given topic, discussion, action, or other piece of the non-linear discussion. A finite life may be a part of the system, or may be selected by the user who initiates the discussion, topic, etc. Also, embodiments include that a user make his or her actions have a finite life. Furthermore, embodiments include that a user have the ability to delete his actions or selectively delete his actions, making them permanently invisible, or selectively invisible to other users.

Moreover, users and their non-linear environment (and their Echoes) may be filtered in any number of ways (for instance, limiting the visible participants to just a user's list of friends) without losing continuity or meaning even though there may be hundreds or thousands of other users that are not visible to the user. A user's Echo may be independent of the Echoes of other users—meaning the user's actions have no contextual dependencies on the actions of other users. This modularity makes it possible, in a non-linear discussion, to add, remove or rearrange the participants without any loss of discussion integrity or cohesion (something that would be very difficult to accomplish in a linear discussion).

While there are many interesting and useful ways to view the actions (or user contributions) of a non-linear discussion, two primary views that can be visualized with this matrix representation would be to view 1) an individual user's Echo, including his or her actions and associated binders and 2) all actions, or a filtered list of actions, by multiple users on a specific binder (i.e. all of the responses by a user's friends to a specific question).

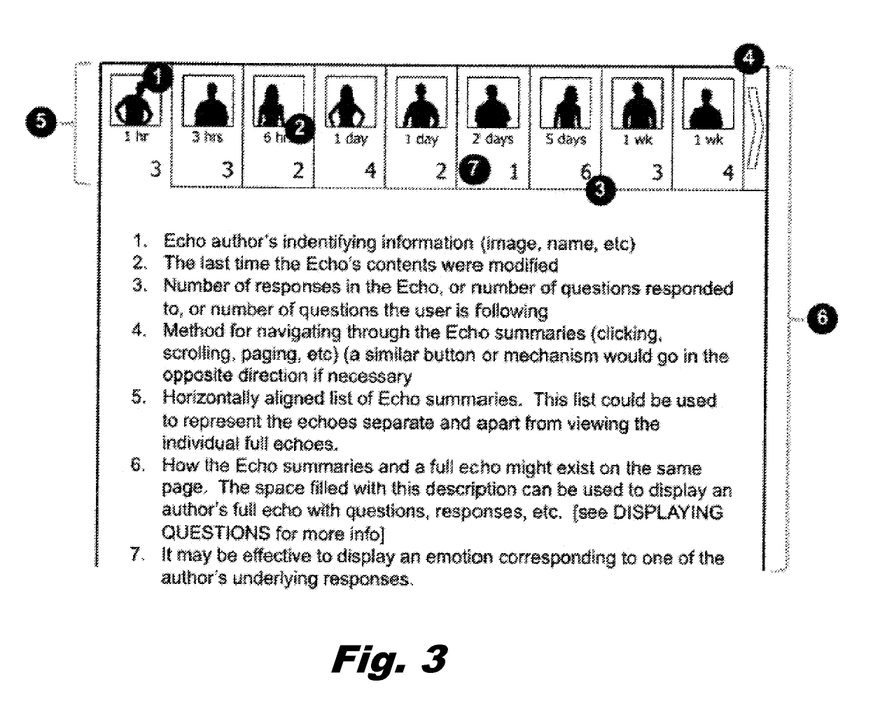

Turning to FIG. 3, a diagram depicts a navigable user list that includes participants in a discussion herein. Embodiments include a horizontal row of tabs complete with summary information specific to each user's Echo of that discussion. Arrows on the side may allow one to browse or slide through the users that are participating in the discussion. Note that many different ways of visualizing the discussion are anticipated. For example, a vertical listing may be used. A search feature may allow a user to find a particular participant. Another search feature may include an alphabetical listing to allow one to quickly scroll through users starting with a particular letter.

Labels are shown in black filled circles with numbers inside the circles. Circle 1 indicates information regarding a participating user. Such information may include, for example, an image used to represent the user, a name associated with the user, and other information that may be used to identify the user.

Circle 2 indicates the last time the Echo's contents were modified. So for example, one hour, two hours, etc. may be displayed.

Circle 3 represents other information that may be presented in the tab. For example, a number of responses in the Echo, a number of questions responded to, or a number of questions the user is following may be displayed in the tab. Other information may also be displayed.

Circle 4 indicates a means for scrolling or searching through Echo summaries of users. As shown, an arrow may be activated. This may be accomplished by hovering a mouse over the arrow, or clicking on the arrow. Clicking, scrolling, paging, etc. may also be used. Note that a similar arrow or button may be used to go the opposite direction of Echoes.

Circle 5 indicates a horizontally aligned row of tabs or list of Echo summaries. This list may be used to represent Echoes separate and apart from viewing the individual full echoes.

Circle 6 represents information on a given Echo, including a tab and then information written below when that tab has been selected. Thus, the tab ad the information may exist on the same page. Information may include the selected user's full echo with questions, responses, etc. Embodiments also include, however, that information be separated from the tab information.

Circle 7 indicates that an emotion corresponding to one of the user's responses be displayed in the user's tab. The emotion may appear instead or along with information displayed below the tab. Emotions may be effecting in adding to the response, making the discussion more lively, and inciting further discussion.

Embodiments include more features or differing features to enhance communication.

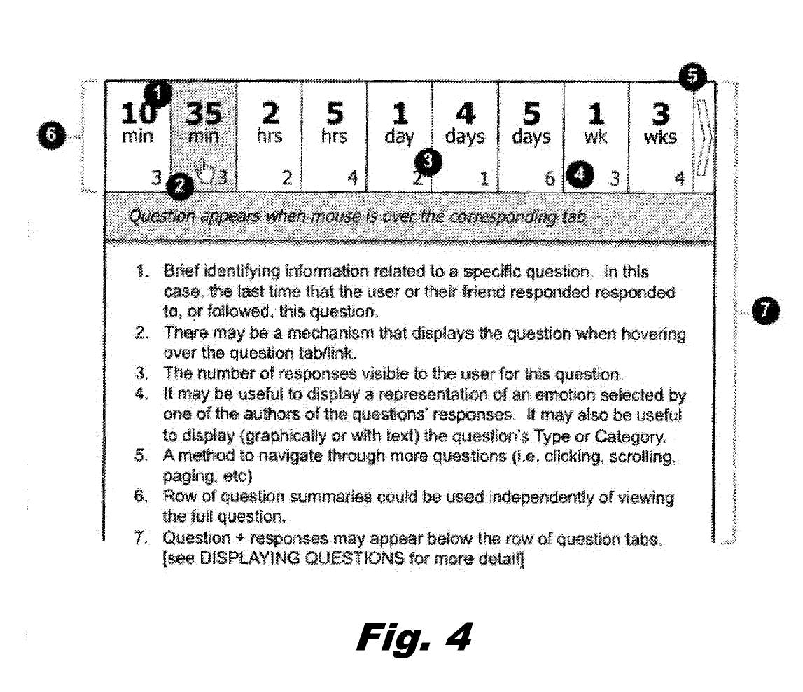

Turning to FIG. 4, a diagram depicts a navigable binder list that includes a list of questions in a row of tabs, one question per tab, complete with summary information specific to each available binder of the discussion.

Embodiments further include that topics, subject matter, or other type of heading also appear in the tabs. Embodiments further include means by which the user may search through questions and topics, similar to the means described previously for Echo searches.

Circle 1 represents brief identifying information related to a specific question that appears in a tab. As shown, this may simply comprise the last time that the viewing user or the participating user responded to, or followed, the question.

Circle 2 represents a question being displayed as the viewing user hovers over a tab associated with the question. Such a feature is advantageous because it allows the viewing user to view the question without clicking for more in-depth information, saving time and unnecessary clicking.

Circle 3 represents a number of responses made visible to the viewing user for a question associated with the tab.

Circle 4 represents an emotion that may be selected or otherwise displayed by a user. Note that embodiments include that a user other than the user that responds to a question be allowed to display an emotion to a response. Whether or not another user may display an emotion may be automatically allowed, preset by the system, controlled by the responding user, etc. In this manner, users may reply to responses with emotions. These variations in emotions may also be applicable to Echoes, described in FIG. 3.

Circle 5 represents a method to navigate through questions. This may be done by clicking, scrolling, paging, etc. This may be accomplished by hovering a mouse over the arrow, or clicking on the arrow. Clicking, scrolling, paging, etc. may also be used. Note that a similar arrow or button may be used to go the opposite direction of question tabs. Searching methods described previously apply here as well.

Circle 6 represents a row of tabs with question summaries. This allows a user to independently view a row of questions summaries without having to view a full question. Note that a variety of views may accomplish this task, such as vertical tabs, pages with alphabetical or some other ordering, etc.

Circle 7 represents both question tabs and responses appearing together, with responses appearing below the row of question tabs. The response for a question may appear when a corresponding tab is selected.

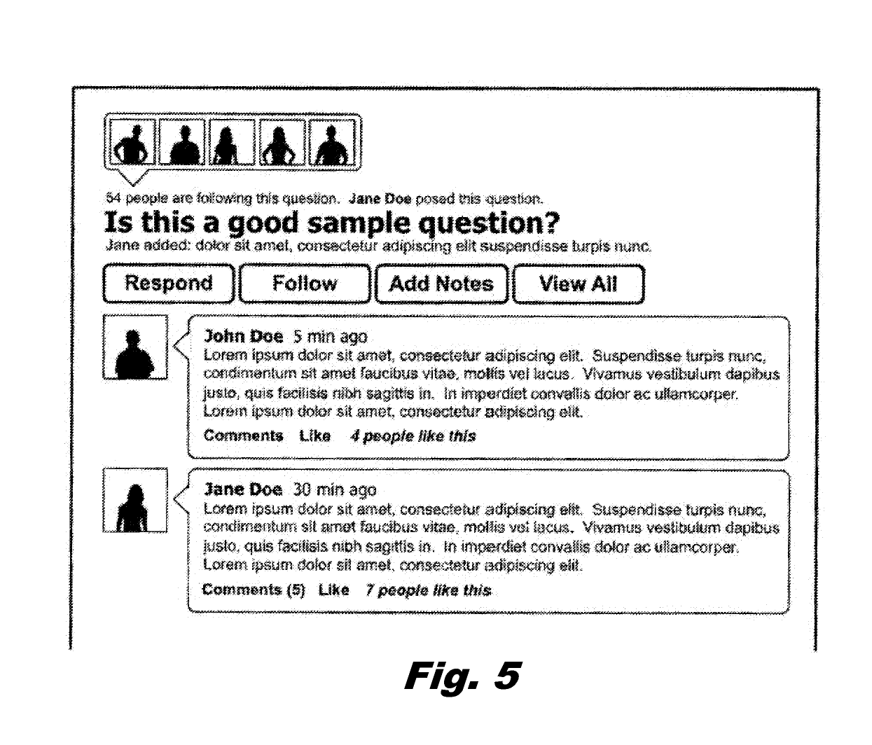

Turning to FIG. 5, a diagram represents a binder and one or more actions performed on the binder by one or more users. In this visualization with a question as the binder, the viewing user might see the question clearly displayed on the page with supporting information also being displayed. The supporting information may include, but is not limited to: representations of friends who are following the question; a count of users who are following the question; the user who originally posed the question; notes that may have been added to the question by the viewing user's friends; links or buttons allowing the viewing user to engage with the question; and responses to the question that the viewing user has access to view.

Viewable responses might be arranged vertically with the most recently posted or modified response listed at the top. Other arrangements and ordering is also anticipated. Supporting information may accompany the response and may include, but is not limited to: an image of the authoring user; the name of the authoring user; a reference to when the response was posted or last edited; option to add/view comments; option to like or dislike; and a count, link or other representation of users who have “liked” the related response.

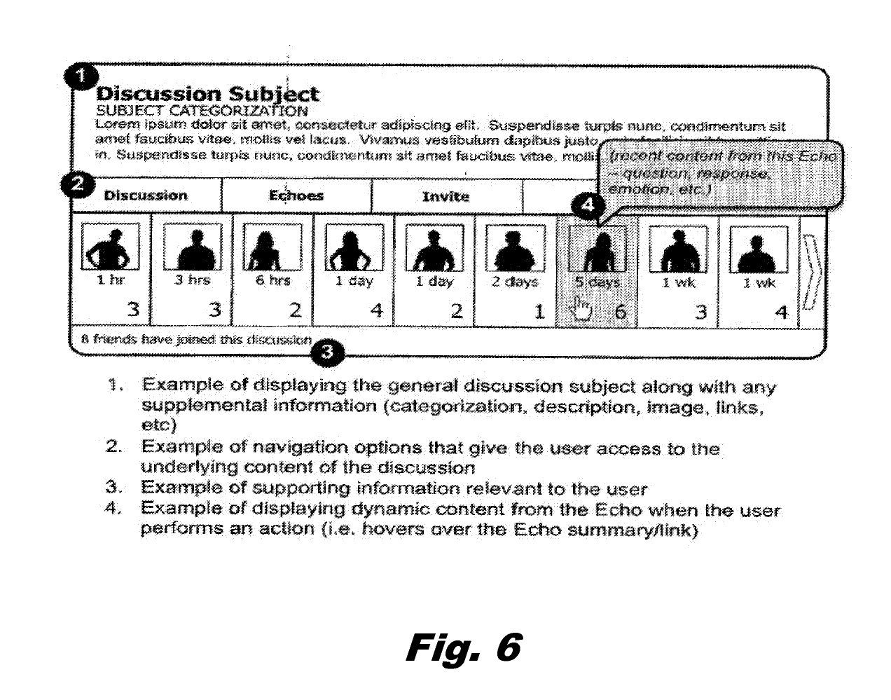

Turning to FIG. 6, a diagram portrays a discussion summary including a representation of recent activity within the discussion from the perspective of the viewing user. A discussion summary may include, but is not limited to: the discussion subject/topic; a categorization of the discussion subject; a description or introduction for the discussion; options for the viewing user to engage, view or otherwise participate in the discussion; a visual representation of users who are participating in the discussion, specifically the viewing user and his/her friends, arranged in order of the most recently active; a representation of a participant's actions within the discussion; and so forth.

Circle 1 represents an example of a discussion subject being displayed. The display may further include supplemental information, such as categorization, description, image, links, etc.

Circle 2 represents an example of navigation options that provide the viewing use with access to underlying content of the discussion. Navigation options may include tabs that represent alternative views, or actions that may be performed. As shown, tabs may include a tab to enter discussion views or echo views. Also, a tab may be displayed that allows a user to invite other users to join a particular discussion, request an action from another user, or invite a person to join the network and become a user. Other tabs may be relevant and are anticipated.

Circle 3 represents supporting information relevant to the viewing user that may also appear. For example, this could be the number of people that have joined the discussion, or the number of people that have responded to the discussion since the last time the viewing user was active.

Circle 4 represents a displaying dynamic content from the Echo when the viewing user performs an action. For example, when the viewing user hovers over the Echo summary or link, recent content from the Echo may appear. This may include a question, response, emotion, times, dates, etc. Anything relevant may be included.

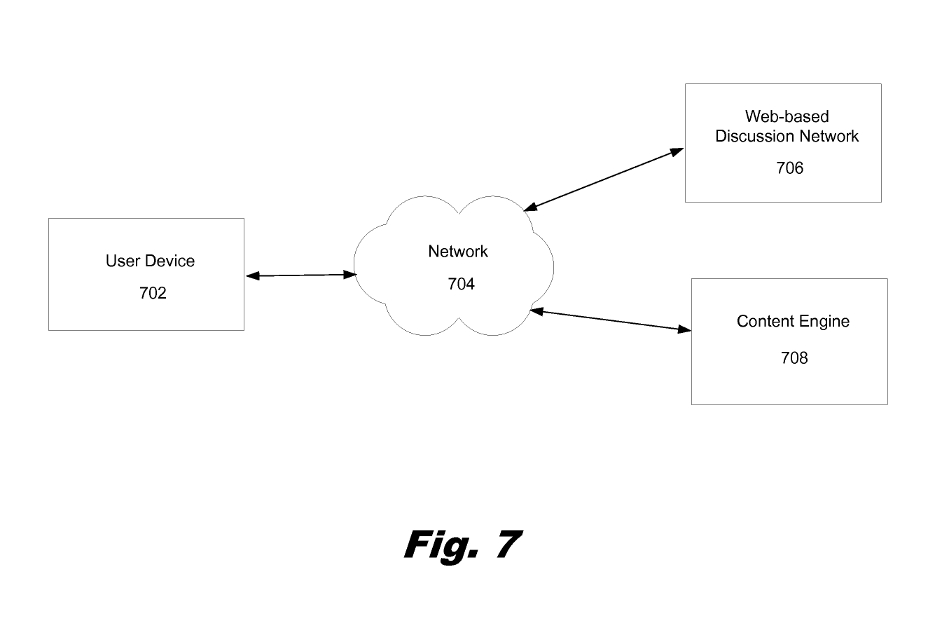

Turning to FIG. 7, an exemplary environment for generating discussion sets and other information for a non-linear discussion network is shown. One or more users, such as a user of at a user device 702, is/are coupled to a web-based discussion network 706 via a network 704.

The web-based discussion network 706 may comprise any entity that provides discussion networking services, communication services, forum groups, etc. For example, the web-based discussion network 706 may host a website that allows one or more users, such as the user at the user device 702, to communicate with one another via the website. For example, a user associated with user device 702 may communicate with one or more second users associated with one or more second user devices via a discussion networking website associated with the web-based discussion network. The discussion website offers the user the opportunity to engage in non-linear discussions with other users of the discussion website.

A content engine 708 is coupled to the web-based discussion network 706. The content engine 708 utilizes action and discussion data to generate a discussion data set to the viewing user at device 702. Also, the content engine 708 utilizes action and discussion data to generate discussion data sets to other users of other devices. According to embodiments, the member device 702 may be directly coupled to the content engine 708. According to embodiments, the content engine 708 comprises a module associated with the web-based discussion network 706.

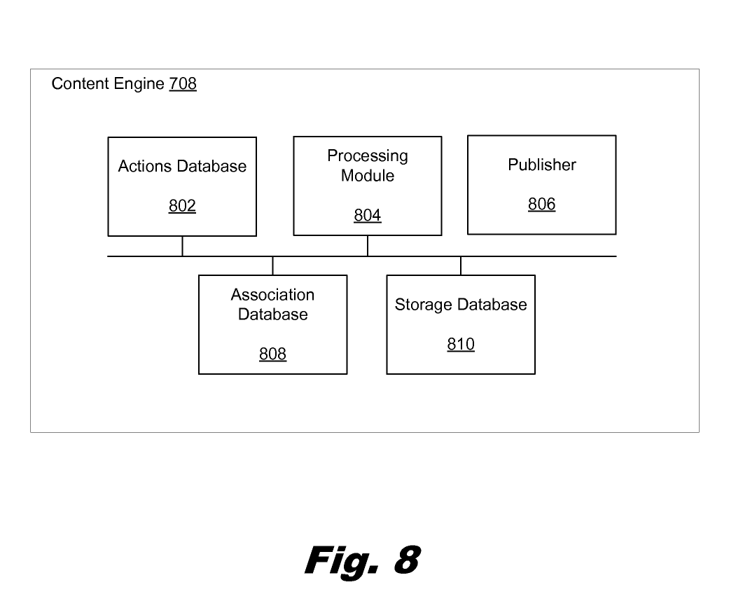

Turning to FIG. 8, an exemplary content engine 708 is shown. Exemplary content engine 708 comprises actions database 802, processing module 804, publisher 806, association module 808, and storage database 810.

Actions database 802 may store one or more user actions or activities on the web-based discussion network 706. For example, the actions database 802 may store user actions with one or more items of content, such as user questions, user profiles, user responses, user email, etc. More generally, any type of user action may be stored in the action database.

According to exemplary embodiments, action data may represent a particular user's actions on the web-based discussion network for a particular period of time, such as the most recent hour, six hours, day, week or month. For example, the viewing user's action data may represent the viewing user's actions for the last hour of entering a response, posting a question, and entering an emotion representation to another user's response.

A processing module 804 may also be provided for performing several functions as described herein in connection with FIG. 8. Among other things, processing module 804 may be responsible for associating user actions with user data to generate discussion data. For example, processing module 804 may associate each action and each user who performs the action to a binder. Also, processing module 804 may access information from each binder, either upon request, by automation, or by other means. Processing module 804 may further identify an aggregate of actions performed on each binder to generate discussion data that is personalized for the viewing user of the web-based discussion network. An association module 808 is provided for associating data with each user device 702. When a user joins web-based discussion network, a user profile may be generated for the user. The user can enter questions, respond to existing questions/binders, assign his or her own personal categories to questions/binders, create groups (family members, co-workers, friends, etc.), and other actions. These actions are then associated with the user. Furthermore, binders, actions, users, and other types of information may be associated with specfic topics.

A publisher 806 may be provided for displaying the generated dynamic content personalized for the viewing user of the web-based discussion network. According to embodiments, publisher 806 comprises a server configured to send the dynamic content to the viewing user for whom the content has been personalized. Also, embodiments include that publisher 806 is configured to format content in a predetermined arrangement style for presentation to the viewing user of the web-based discussion network. The arrangement style may also be determined in other ways for viewing.

A discussion set that is generated for a user may include a number of different views. For example, a view may include at least information for at least one action and at least one binder associated with at least one selected user. Another view may include at least one action and at least one user associated with at least one selected binder. Another view may include a list or information regarding at least one binder and a summary of at least one action associated with at least one selected binder.

Embodiments include that publisher 806 display a navigable user list, and display the navigable user list to the viewing user. In conjunction with the navigable user list, or as a separate action, the publisher 806 may display a discussion set that is associated with a selected user.

Along with the display of the navigable user list, the publisher 806 may further generate and display a summary representation of each user contained in the navigable user list. Each summary representation may include an aggregate of the actions by each user within the discussion set. A summary representation of a relationship of the viewing user with the actions may also be displayed.

Embodiments include that publisher 806 display a navigable binder list. This may also include a discussion set associated with a binder that is selected. Embodiments include that summary representations for each binder in the navigable binder list be displayed. The summary representations may include an aggregate of actions performed on each binder. A summary representation of a relationship of the viewing user with the actions may also be displayed.

Embodiments include a display of information for multiple discussion sets. This may include information for recent and relevant action for a given discussion set. The information may include one or more graphic representations of users who have performed actions in the discussion set, a count of actions taken, a count of unviewed actions by users, user-specific emotions, and a date of a last action by a user.

Note that a filter may be applied to information for discussions, binders, actions and users to create greater social relevance to the viewing user.

A storage database 810 may store any number of items described herein. Embodiments further include that the storage database 810 store personalized notes from users to corresponding binders. Personalized notes may include graphical displays of emotion, personal messages, links, and other types of information. The personalized notes may be made visible to users according to a ranking order based on time of delivery, social relevance to the user, status of importance, or other ordering system. Social relevance to the user may be based on a ranking set by the viewing user, the relationship of the authorizing user to the viewing user, or some other ranking method.

Although the exemplary content engine 708 is described as being comprised of various components (actions database 802, processing module 804, publisher 806, association module 808, and storage database 810), fewer or more components may comprise the content engine 708 and still fall within the cope of embodiments.

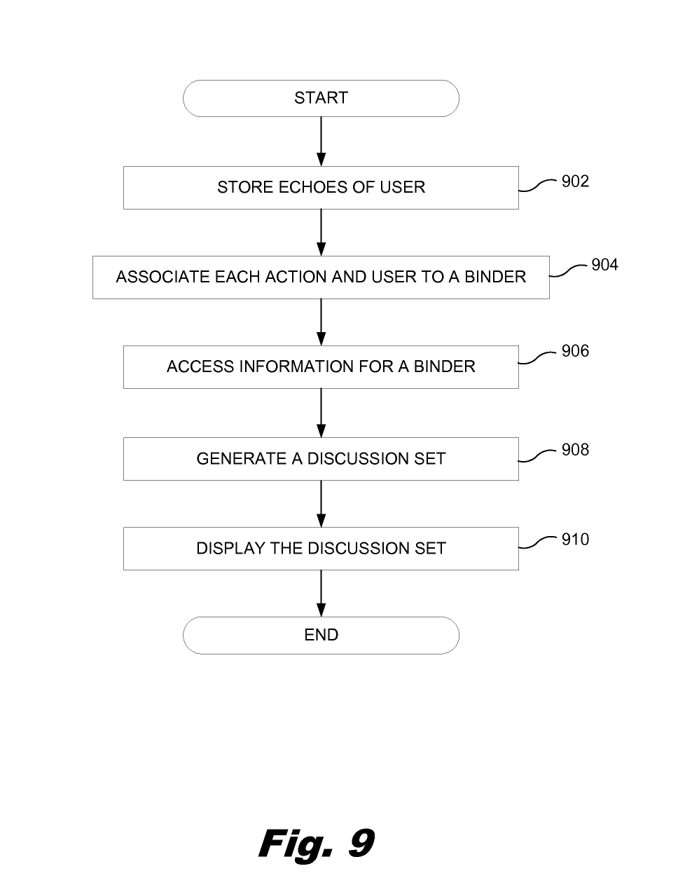

Turning to FIG. 9, a flow diagram represents a simplified expression of how to generate a personalized non-linear discussion set for a viewing user. Embodiments include that a non-linear discussion set includes at least one user, at least one action and at least one binder. A user may perform an action and that action may be associated with a binder. The binder and any associated actions can then be accessed to generate a discussion set. The discussion set is then available for display to the viewing user. Note that steps presented herein may be performed in a different order. Steps may be added. Steps may be omitted and replaced with other steps gleaned from the description. Also, other variations are envisioned.

At step 902, at least one action of one or more users of web-based discussion network 706 (FIG. 7) is stored. The action may represent any action as has been discussed pertaining to the web-based discussion network and for a particular time.

At step 904, at least one action is associated with a user and a binder. At step 906, information for a binder may be accessed. This may include a discussion set, actions taken on a binder, multiple discussion sets that are related or unrelated, and other information discussed herein.

At step 908, a discussion set may be generated for a viewing user. Along with discussion sets, other information may be presented automatically or as desired by the viewing user.

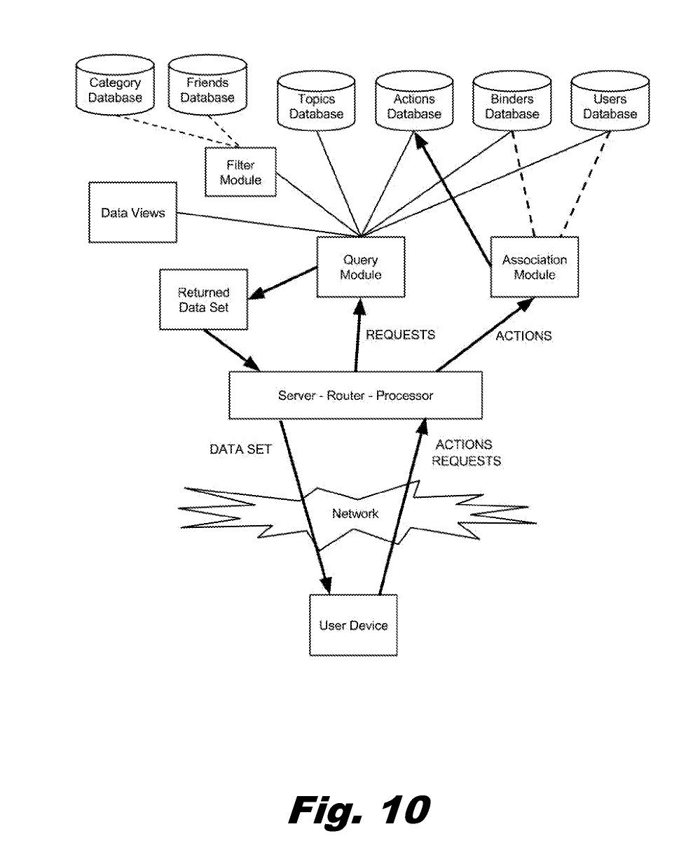

Turning to FIG. 10, an illustration portrays a basic flow diagram of a user experience in a non-linear discussion network. A user may interact with the non-linear discussion network through a device connected to a network. User inter-action can be thought of as user-initiated actions (generation of content) and requests (viewing content). These actions are sent over a network and are received and handled by a server, router and/or processor. Actions are associated with the user and the binder they are acting upon and are then stored in a database or some other data store (i.e. data cache). Requests may involve a query function (i.e. retrieving code from a file system, retrieving stored data sets from temporary cache, or generating a new data set). When a new data set is being generated, the query module may query any of a number of databases (or tables within a single database). Filters and data views (code templates) may be used to determine which data should be retrieved and how the results should be displayed for the requesting user. The generated or retrieved data set is then returned to the user's device over the network.

Note that steps presented herein may be performed in a different order. Steps may be added. Steps may be omitted and replaced with other steps gleaned from the description. Also, other variations are envisioned.

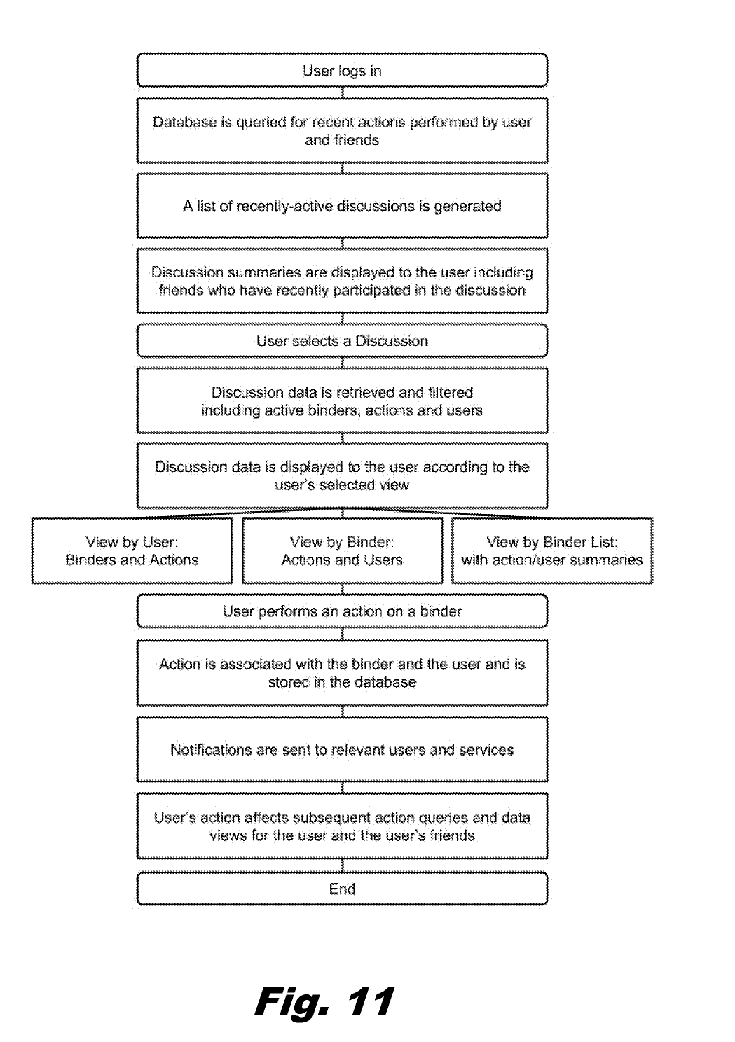

Turning to FIG. 11, a flow diagram illustrates an example of a user experience in a non-linear discussion network. Once a user has logged in, the recent actions of the user and his/her friends are retrieved and a list of recently-active discussions is generated. Discussion summaries are then displayed to the user including a list of recently active friends within the discussion. The user navigates this list of discussion summaries and chooses a discussion to view. A detailed data set is then retrieved for the selected discussion and displayed to the user according to any of a series of possible “views”. Within the selected view, the user is presented one or more binders and has the option to perform an action on the binder (i.e. respond to, or follow, a question). When the user performs an action, the action is associated with the binder and stored in a database. Notifications are then sent to relevant parties. Subsequent queries and views of the discussion, whether by the user or the user's friends, will be updated to reflect the user's recent action.

Note that steps presented herein may be performed in a different order. Steps may be added. Steps may be omitted and replaced with other steps gleaned from the description. Also, other variations are envisioned.

In summary, non-linear discussions are believed to enhance and increase communication. For example, imagine walking into great discussions that have already been vetted by your friends. Imagine being given the ability to discuss interesting topics in great depth with your entire social network. This results in deeper, more fulfilling connections to your social circle, and greater understanding of who your friends really are, through meaningful and substantive discussions. Furthermore, this provides a centralized landing point, unlimited shelf life, and extensive reach within our social network and greater motivation for users to participate in this type of discussion.

Embodiments of this invention may also include a computer-readable medium having embodied thereon a program, the program being executable by a processor for performing a method, as described herein, for generating discussion sets and other discussion content, for users of a web-based non-linear discussion network.

What is claimed is:

1. A method for generating a non-linear discussion set comprising:
combining actions performed by a user into an echo,
storing echoes from the user and other users,
associating to a common binder selected actions in the stored echoes that comprise predefined binder criteria,
generating a discussion set comprising actions and users associated with the binder,
displaying the discussion set to the viewing user.

2. The method of claim 1, wherein the binder is created and defined from user action, and subsequent user actions that comprise the specific predefined binder criteria are associated with the binder.

3. The method of claim 1, further comprising generating at least one view of the discussion set, the view including but not limited to: 1) at least one action and at least one binder associated with at least one selected user; 2) at least one action and at least one user associated with at least one selected binder; and 3) a list of at least one binder and a summary of at least one action associated with at least one selected binder.

4. The method of claim 1, further comprising
storing personalized notes from users to binders, and making the personalized notes visible to users according to a rank on social relevance of the authoring user to the viewing user.

5. The method of claim 1, further comprising
associating echoes and related binders, actions and users into discussions with specific topics.

6. The method of claim 3, further comprising
generating a navigable user list, displaying the navigable user list to the viewing user, and further displaying a discussion set associated with a user that is selected.

7. The method of claim 6, further comprising
generating and displaying a summary representation of each user in the navigable user list, each summary representation including an aggregate of the actions by each user within the discussion set as well as a summary representation of a relationship of the viewing user with the actions.

8. The method of claim 3, further comprising
generating a navigable binder list;
displaying the navigable binder list to the viewing user; and
displaying a discussion set associated with a binder that is selected.

9. The method of claim 8, further comprising
generating and displaying a summary representations for each binder in the navigable binder list, each summary representation including an aggregate of actions performed on each binder as well as a summary representation of a relationship of the viewing user with the actions.

10. The method of claim 5, further comprising
displaying information of multiple discussions and discussion sets including a recent and relevant action within each discussion set, the information including, but not limited to one or more of a graphic representation of users who have performed actions in the discussion set, a count of actions taken, a count of unviewed actions by users, user-specific emotions, and a date of a last action by a user.

11. The method of claim 5, further comprising
filtering of discussions, echoes, binders, actions and users for greater social relevance to the viewing user.

12. A system comprising:
one or more computers; and
a computer-readable medium coupled to one or more computers having instructions stored thereon which, when executed by the one or more computers, cause the one or more computers to perform operations comprising:
receiving, from a computing device, a submitted action by a user;
associating the submitted action to a binder;
storing submitted action in a database;
combining submitted actions by users into echoes;
receiving, from a computing device, a request to view a discussion set comprised of binders, actions and users associated with one or more echoes;
generating requested discussion set;
transmitting requested discussion set for display in a respective page associated with the account of the requesting user.

13. The system of claim 12, wherein the binder is created and defined from user action, and subsequent user actions that comprise the specific predefined binder criteria are associated with the binder.

14. The system of claim 12, wherein the operations further comprise:
generating at least one view of the discussion set, the view including but not limited to: 1) at least one action and binder associated with at least one selected user; 2) at least one action and at least one user associated with at least one selected binder; and 3) a list of at least one binder and summaries of at least one action associated with at least one binder.

15. The system of claim 12, wherein the operations further comprise:
storing notes by users on a specific binder; and
transmitting the notes with the associated binder for display to a requesting user with the visibility of the notes dependent upon the social relevance of the authoring user to the viewing user.

16. The system of claim 12, wherein the operations further comprise:
associating echoes and related binders, actions and users into discussions with specific topics.

17. The system of claim 16 wherein the operations further comprise:
generating a navigable user list;
transmitting the user list for display to a viewing user; and
receiving and processing a request from a viewing user to view the associated data set of a selected user.

18. The system of claim 17, wherein the navigable user list includes summary representations for each user, with each summary including an aggregate of the user's actions within the discussion as well as representations of the viewing user's relationship with those actions.

19. The system of claim 16, wherein the operations further comprise:
retrieving a consolidated data set comprised of multiple discussion summaries, which summaries may include but are not limited to: 1) the discussion topic, 2) a description of the discussion, 3) related links, tags and media, 4) navigable user list including summary data comprised of the actions of the user relative to the discussion;
filtering of data set for social relevance to the requesting user; and
transmitting of retrieved data set for the display in a respective page associated with the account of the requesting user.

20. The system of claim 16, wherein the operations further comprise:
filtering of discussions, binders, actions and users for greater social relevance to the viewing user; and
transmitting the filtered data for display to the viewing user.
